(19) United States
(12) Patent Application Publication
(10) Pub. No.: US 2012/0271902 A1
(43) Pub. Date: Oct. 25, 2012

(54) SELECTING FORWARDING DEVICES IN A WIRELESS COMMUNICATION NETWORK

(75) Inventors: Roshan R. Baliga, Bangalore (IN); Steven J. Kuhn, Santa Clara, CA (US)

(73) Assignee: Atheros Communications, Inc., San Jose, CA (US)

(21) Appl. No.: 13/090,784

(22) Filed: Apr. 20, 2011

(51) Int. Cl. G06F 15/173; G06F 15/16

(52) U.S. Cl. 709/209; 709/239

(57) ABSTRACT

A forwarding device can establish a communication link with both a source device and a destination device to extend the communication range of the source device by forwarding data from the source device to the destination device. A coordinating device can be configured to identify a forwarding client through which to communicate with a client station that is inaccessible to the coordinating device via a direct communication link, based on the throughput achieved on communication links between the coordinating device, the inaccessible client, and accessible clients. The throughput achieved on the communication links can be determined by exchanging training packets, receiving acknowledgement messages in response to the training packets, and subsequently analyzing the received acknowledgement messages. Based on the calculated throughputs, one of the accessible clients can be designated as the forwarding client with respect to the coordinating device and the inaccessible client.

### BACKGROUND

Embodiments of the inventive subject matter generally relate to the field of wireless communication networks and, more particularly, to a mechanism for selecting forwarding devices in a wireless communication network.

Client stations in a wireless local area network (WLAN) that implement a tunneled direct link setup (TDLS) communication protocol can establish and exchange information via a direct communication link with other client stations that implement the TDLS protocol. The client stations that can establish a direct communication link with both a source client station and a destination client station can be used as forwarding client stations to extend the communication range of the source client station by routing (or forwarding) packets from the source client station to the destination client.

### SUMMARY

Various embodiments for selecting forwarding devices in a wireless communication network are disclosed. In one embodiment, a throughput associated with a direct communication link between a coordinating device and each of a plurality of client stations associated with a wireless communication network is determined. An inaccessible client station from the plurality of client stations that is inaccessible to the coordinating network device via the direct communication link is identified. One or more accessible client stations from the plurality of client stations that are accessible to the coordinating device via the direct communication link are also identified. The inaccessible client station and the one or more accessible client stations are identified based, at least in part, on the throughput associated with the direct communication link between the coordinating network device and each of the plurality of client stations. An accessible client station from the one or more accessible client stations is designated as a forwarding client station with respect to the coordinating device and the inaccessible client station based, at least in part, on a cumulative throughput associated with a communication link between the coordinating network device and the inaccessible client station via the accessible client station. Data is transmitted from the coordinating network device to the inaccessible client station via the forwarding client station.

### BRIEF DESCRIPTION OF THE DRAWINGS

The present embodiments may be better understood, and numerous objects, features, and advantages made apparent to those skilled in the art by referencing the accompanying drawings.

FIG. 1 is an example conceptual diagram illustrating a mechanism for selecting forwarding deices in a wireless communication network;

FIG. 2 is a flow diagram illustrating example operations of a coordinating device configured to select forwarding devices in a wireless communication network;

FIG. 3 is a continuation of FIG. 2 and also illustrates example operations of a coordinating device configured to select forwarding devices in a wireless communication network;

FIG. 4 is a continuation of FIG. 3 and also illustrates example operations of a coordinating device configured to select forwarding devices in a wireless communication network;

FIG. 5 is a flow diagram illustrating example operations of a client station communicating with a coordinating device configured to select forwarding devices in a wireless communication network;

FIG. 6 is an example timing diagram illustrating example messages exchanged for selecting forwarding devices in a wireless communication network;

FIG. 7 is a continuation of FIG. 6 also illustrates example messages exchanged for selecting forwarding devices in a wireless communication network; and

FIG. 8 is a block diagram of one embodiment of an electronic device including a mechanism for identifying forwarding devices in a wireless communication network.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. For instance, although examples refer to identifying forwarding devices in a wireless local area network (WLAN), embodiments are not so limited. In other embodiments, the operations for identifying forwarding devices can be implemented by other wireless communication standards and devices (e.g., Worldwide Interoperability for Microwave Access (WiMAX)). In other instances, well-known instruction instances, protocols, structures, and techniques have not been shown in detail in order not to obfuscate the description.

Traditionally, mechanisms for identifying a wireless device (“forwarding device”) through which to route data packets to a destination device have relied on the received signal strength indicator (RSSI) associated with signals received at one or more of wireless devices in the wireless communication network. However, traditional mechanisms for identifying the forwarding device may not be able to accurately estimate the communication bandwidth available to the destination device. The traditional mechanisms for identifying the forwarding device may also not take into consideration the performance requirements (e.g., throughput requirements) associated with the destination device. Consequently, the traditional mechanisms may be unable to determine whether the available bandwidth can support communication (e.g., transfer of video data packets) from a source device to the destination device via the forwarding device. Thus, relying on the RSSI to select the forwarding device may impair communication between the source device and the destination device and may consequently minimize the performance of the destination device.

Wireless devices in the wireless communication network can implement functionality for identifying forwarding devices for communicating with one or more other wireless devices in the wireless communication network taking various performance requirements (e.g., bandwidth and throughput requirements) into consideration. In one embodiment, a coordinating device in the wireless communication network can determine the throughput achieved on communication links between the coordinating device and each of the other wireless devices in the wireless communication network. The coordinating device can cause one or more of the other wireless devices to determine the throughput achieved on communication links between the wireless device and the remainder of the wireless devices in the wireless communication network. The coordinating device can then analyze the determined throughputs to identify wireless devices (“inaccessible devices”) with which the coordinating device cannot establish a direct communication link. The coordinating device can then analyze the determined throughputs to identify forwarding devices through which an indirect communication link can be established with the inaccessible devices. Such a mechanism for identifying the forwarding device can enable bandwidth, throughput, and other performance measurements to be estimated more accurately and can improve the performance of the wireless communication network. Identifying a forwarding device from one of the wireless devices within the wireless communication network can also eliminate the need for a wireless repeater and can expand the capabilities of wireless communication networks that support direct communication protocols (e.g., Tunneled Direct Link Setup (TDLS) protocols) by enabling communication when the direct communication link between two wireless devices cannot be established.

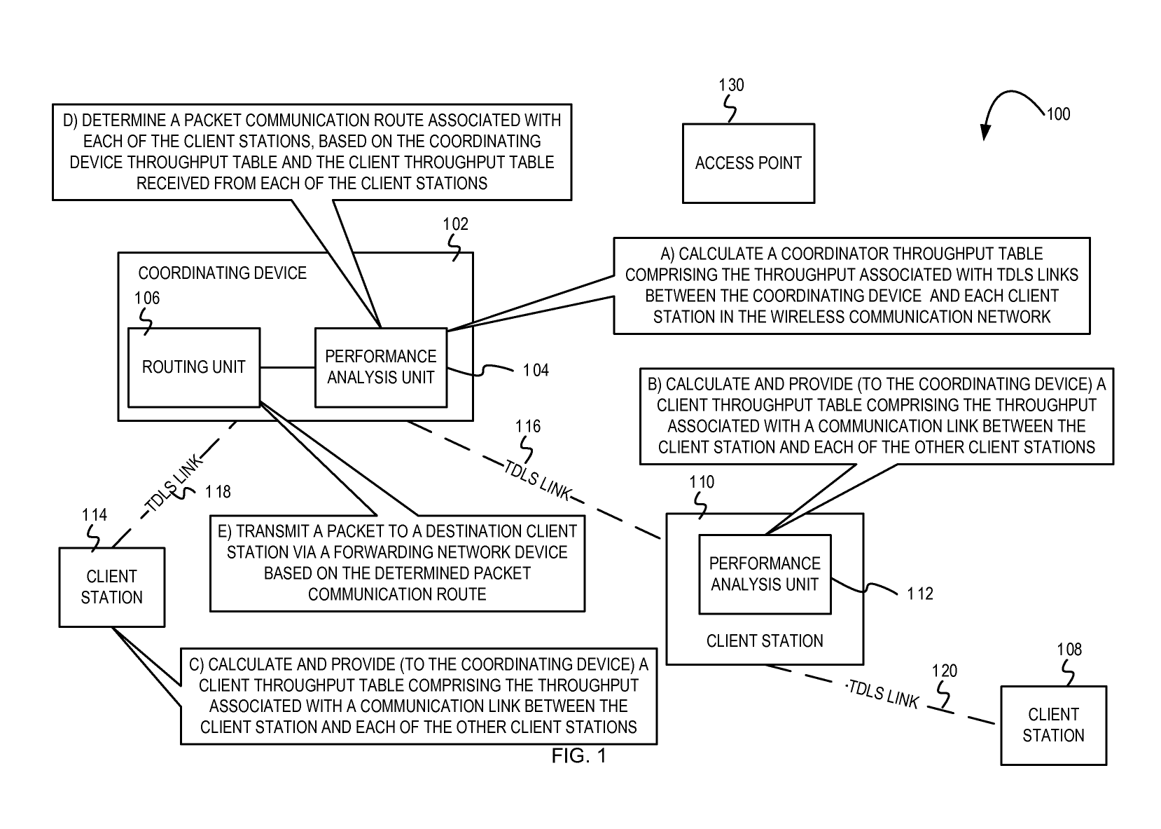

FIG. 1 is an example conceptual diagram illustrating a mechanism for selecting forwarding devices in a wireless communication network 100. The wireless communication network 100 comprises a coordinating device 102 and client stations 108, 110, and 114. The coordinating device 102 comprises a performance analysis unit 104 and a routing unit 106. The client station 110 comprises a performance analysis unit 112. Although not depicted with reference to FIG. 1, each of the client stations 108 and 114 can also comprise their respective performance analysis units. In one implementation, the coordinating device 102 and the client stations 108, 110, and 114 can be wireless local area network (WLAN) devices. In some implementation, the wireless communication network 100 can be employed for applications (e.g., video over wireless (VoW) applications) that are expected to meet certain predetermined performance requirements (e.g., a target bandwidth).

The wireless communication network 100 also comprises an access point 130. The coordinating device 102 and the client stations 108, 110, and 114 can each be wireless devices that initially connect to the access point 130. With reference to FIG. 1, the wireless device 102 is designated as the coordinating device (or a master wireless device) that coordinates communication among all the wireless devices 102, 108, 110, and 114 in the wireless communication network. For example, when the wireless communication network 100 is a home network, digital video recorder (DVR) functionality can be restricted to one wireless device (e.g., the coordinating device 102) that comprises content storage and content recording functionality. The coordinating device 102 can attempt to establish a direct communication link (e.g., a TDLS communication link) with each of the client stations 108, 110, and 114 in the wireless communication network 100. The client stations 108, 110, and 114 can be thin clients without actual DVR functionality. The coordinating device 102 can stream content to the client stations 108, 110, and 114 via the direct communication link (if established). In other words, the coordinating device 102 can receive/store content (e.g., video, audio, multimedia content, etc.) from the access point 130 and can stream this content (on request) to the client stations 108, 110, and 114, precluding the client stations 108, 110, and 114 for maintaining a communication link with the access point 130. It is noted that after the direct communication links between the wireless devices 102, 108, 110, and/or 114 are established, the wireless devices 102, 108, 110, and 114 can disassociate from the access point 130. Subsequent communication between the wireless devices 102, 108, 110, and 114 need not occur via the access point 130, but instead can occur via the direct communication links established between the wireless devices 102, 108, 110, and 114. As will be described below with reference to stages A-E, the coordinating device 102 can identify which of the client stations in the wireless communication network 100 is best suited for forwarding packets to one or more other client stations in the wireless communication network 100.

At stage A, the performance analysis unit 104 of the coordinating device 102 calculates a coordinator throughput table comprising the throughput associated with TDLS links between the coordinating device 102 and each client station in the wireless communication network 100 (“coordinator-client throughput”). In some implementations, the coordinating device 102 can itself identify the client stations 108, 110, and 114 in the wireless communication network 100. For example, the coordinating device 102 can broadcast beacon messages to identify (e.g., based on whether responses to the beacon messages are received, based on content of the received responses, etc.) the client stations in the wireless communication network 100 that support the TDLS protocol. The coordinating device 102 can then exchange handshake messages with the client stations that support the TDLS protocol and can attempt to establish a TDLS communication link with each of the client stations. In another implementation, the coordinating device 102 can query the access point 130 of the wireless communication network 100 for a list of the client stations 108, 110, and 114 in the wireless communication network 100 that support the TDLS protocol. In another implementation, a network administrator can program, in the coordinating device 102, information (e.g., a network address) identifying the client stations 108, 110, and 114 that support the TDLS protocol. The coordinating device 102 is initially configured in the master operating mode and the client stations 108, 110, and 114 are configured in the slave operating mode. With reference to FIG. 1, the coordinating device 102 establishes a TDLS link 116 with the client station 110 and a TDLS link 118 with the client station 114. In this example, the coordinating device 102 is unable to establish a TDLS link with the client station 108. In other words, the client station 108 is inaccessible to the coordinating device 102 and is herein referred to as an “inaccessible client station.” As will be described below, in order to communicate with the inaccessible client station 108, the coordinating device 102 can determine whether the client station 110 or the client station 114 can act as a forwarding device to the inaccessible client station 108 by establishing a TDLS link with the inaccessible client station 108.

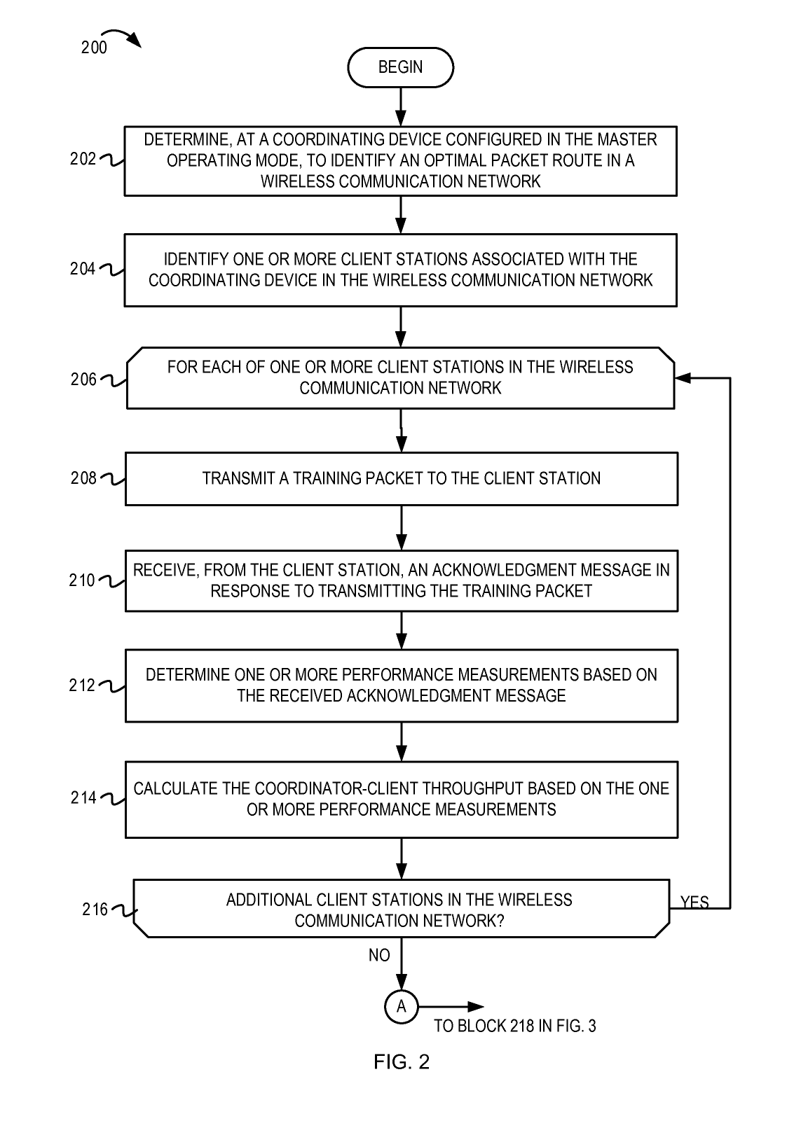

To determine the coordinator throughput table, the performance analysis unit 104 generates and transmits training packets to the client stations 110 and 114 with which the coordinating device 102 has established the TDLS communication links 116 and 118 respectively. In one implementation, the training packets can comprise a predetermined data sequence encapsulated by suitable WLAN packet headers. It is noted, however, that in other implementations the training packets can be formed differently; for example, the training packets can comprise randomly generated data encapsulated by the WLAN packet headers. In some implementations, the performance analysis unit 104 may transmit one training packet to the client station 110 and the client station 114. In another implementation, the performance analysis unit 104 may transmit (across a predetermined number of time intervals) any suitable number of packets to the client stations 110 and 114. In response to the training packets, the performance analysis unit 104 can receive one or more acknowledgement messages from the client stations 110 and 114. As will be described with reference to blocks 208-214 of FIG. 2, the performance analysis unit 104 can determine one or more performance measurements (e.g., packet error rate or PER) associated with the acknowledgment messages received from the client stations 110 and 114. Based on these performance measurements, the performance analysis unit 104 can then calculate the coordinator-client throughput associated with the client stations 110 and 114. The performance analysis unit 104 can store the calculated coordinator-client throughputs in the coordinator throughput table for subsequent analysis (as will be described with reference to stages D-E). After the coordinator throughput table is generated, the coordinating device 102 can select a client station (e.g., the client station 110), switch to the slave operating mode, and cause the client station to assume the role of the coordinating device (i.e., switch to the master operating mode) in the wireless communication network 100 for measurement purposes.

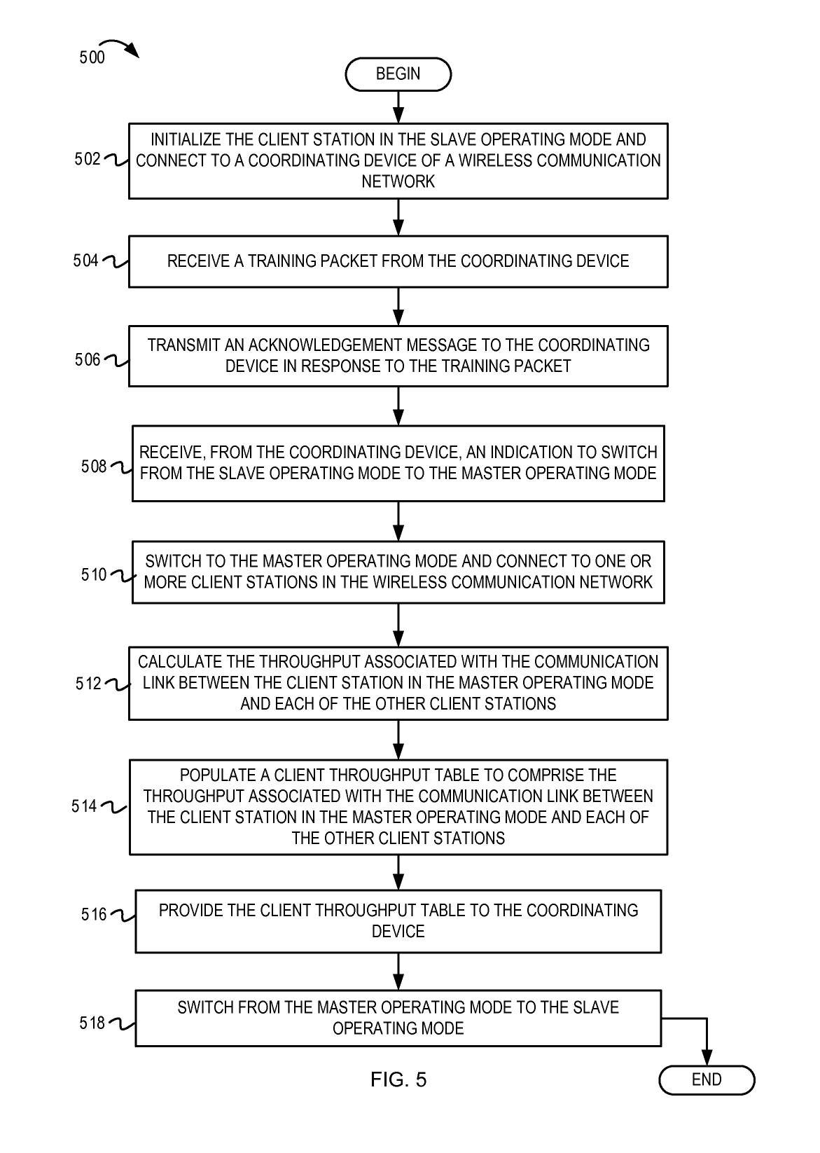

At stage B, the performance analysis unit 112 of the client station 110 calculates a client throughput table comprising the throughput associated with the communication links between the client station 110 and each of the other client stations in the wireless communication network 100. The client station 110 switches to the master operating mode on receiving an indication (e.g., a control message) from the coordinating device 102. The other client stations 108 and 114 (including the coordinating device 102 configured in the slave operating mode) connect to and associate with the client station 110 configured in the master operating mode. The client station 110 establishes a TDLS link 120 with the client station 108. Although not depicted in FIG. 1, the client station 110 can also establish a TDLS link with the client station 114. As will be described with reference to blocks 208-214 of FIG. 2 and blocks 512-514 of FIG. 5, the performance analysis unit 112 transmits training packets to the client stations 108 and 114, and subsequently receives acknowledgement messages in response to the training packets. The performance analysis unit 112 then determines performance measurements associated with the received acknowledgment messages and determines the throughputs based on the performance measurements. In some implementations, the performance analysis unit 112 can also determine the throughput associated with the communication link 116 between the client station 110 and the coordinating device 102. The performance analysis unit 112 can store the throughputs associated with the communication links between the client station 110 and each of the other client stations in the wireless communication network 100 in a client throughput table. The performance analysis unit 112 can provide the client throughput table generated by the client station 110 to the coordinating device 102. Subsequently, the client station 110 can switch from the master operating mode to the slave operating mode and the coordinating device 102 can switch from the slave operating mode to the master operating mode. The coordinating device 102 can then select the client station 114, switch to the slave operating mode, and can cause the client station 114 to switch to the master operating mode for measurement purposes.

At stage C, the performance analysis unit of the client station 114 calculates a client throughput table comprising the throughput associated with the communication links between the client station 114 and each of the other client stations in the wireless communication network 100. As described above with reference to stage B, and as will be described with reference to blocks 208-214 of FIG. 2 and blocks 512-514 of FIG. 5, the performance analysis unit can determine a client throughput table associated with the client station 114. The performance analysis unit can provide the client throughput table associated with the client station 114 to the coordinating device 102. Subsequently, the client station 114 can switch from the master operating mode to the slave operating mode, and the coordinating device 102 can switch from the slave operating mode to the master operating mode. It is noted that the coordinating device 102 can successively cause each of the client stations with which a direct communication link can be established (“accessible client stations”) to switch to the master operating mode and determine a corresponding client throughput table. The performance analysis unit 104 can execute operations described below with reference to stages D-E after the client throughput tables are received from each of the accessible client stations (e.g., client stations 110 and 114).

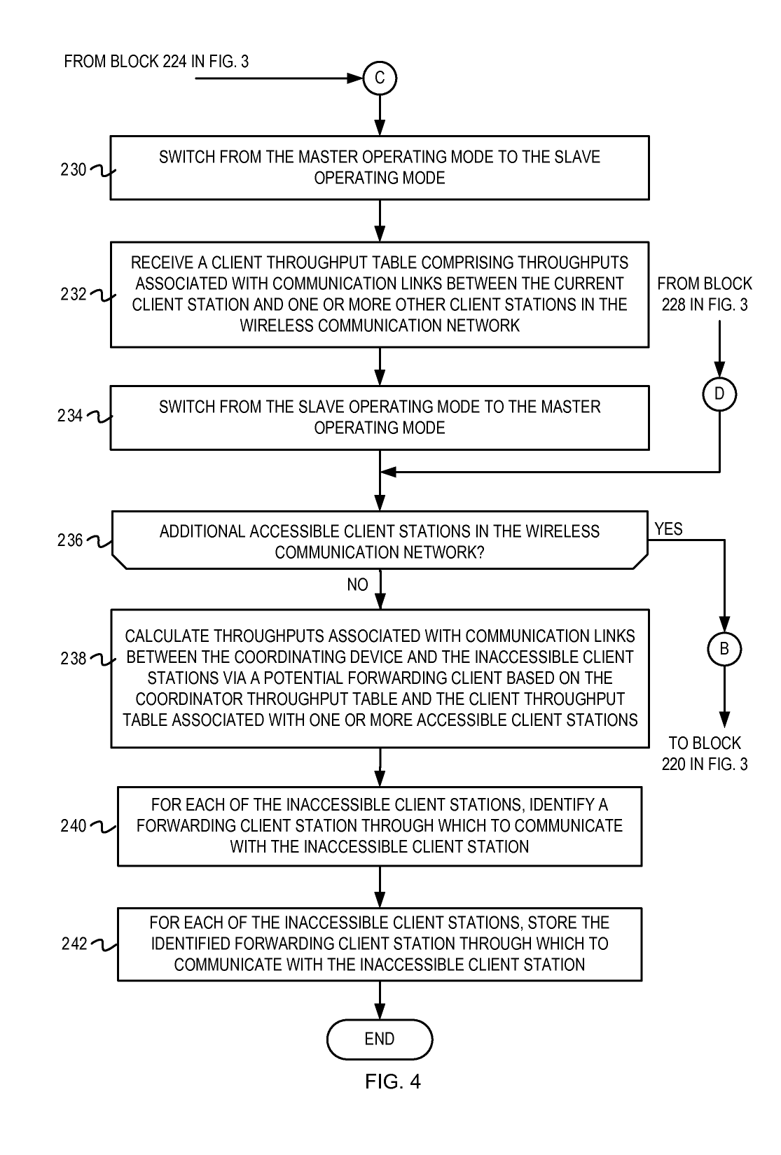

At stage D, the performance analysis unit 104 determines a packet communication route associated with each of the client stations, based on the coordinating device throughput table and the client throughput table received from each of the client stations. In other words, the performance analysis unit 104 can determine the forwarding client station through which to route packets if the destination wireless device is an inaccessible client station. In one implementation, the performance analysis unit 104 can determine the throughput associated with a communication link between the coordinating device 102 and the inaccessible client station 108 via the other client stations 110 and 114, as will be described with reference to block 240 of FIG. 4. In the example shown in FIG. 1, the performance analysis unit 104 may determine that to communicate with the inaccessible client station 108, the best throughput is achieved when packets are routed from the coordinating device 102 to the client station 108 via the client station 110. Therefore, the client station 110 can be identified (e.g., in a routing data structure) as the forwarding client station associated with the inaccessible client station 108.

At stage E, the routing unit 106 transmits a packet to a destination client station via a forwarding network device based on the determined packet communication route. In response to determining to transmit a packet to the destination client, the routing unit 106 can access the routing data structure to determine whether a direct communication link was established between the coordinating device 102 and the destination client station. For example, in response to determining to transmit a packet to the destination client 110, the routing unit 106 can determine that the TDLS link 116 was established between the coordinating device 102 and the destination client station 110. The routing unit 106 can then directly transmit the packet to the destination client 110 via the TDLS link 116. As another example, in response to determining to transmit a packet to the destination client 108, the routing unit 106 can determine that a TDLS link could not be established between the coordinating device 102 and the destination client station 108. The routing unit 106 can identify a forwarding client station (e.g., the client station 110) that can be used to forward packet(s) to the destination client station 108. The routing unit 106 can then transmit the packet to the forwarding client station via the TDLS link 116, and can cause the forwarding client station to route the packet to the destination client station 108 via the TDLS link 118.

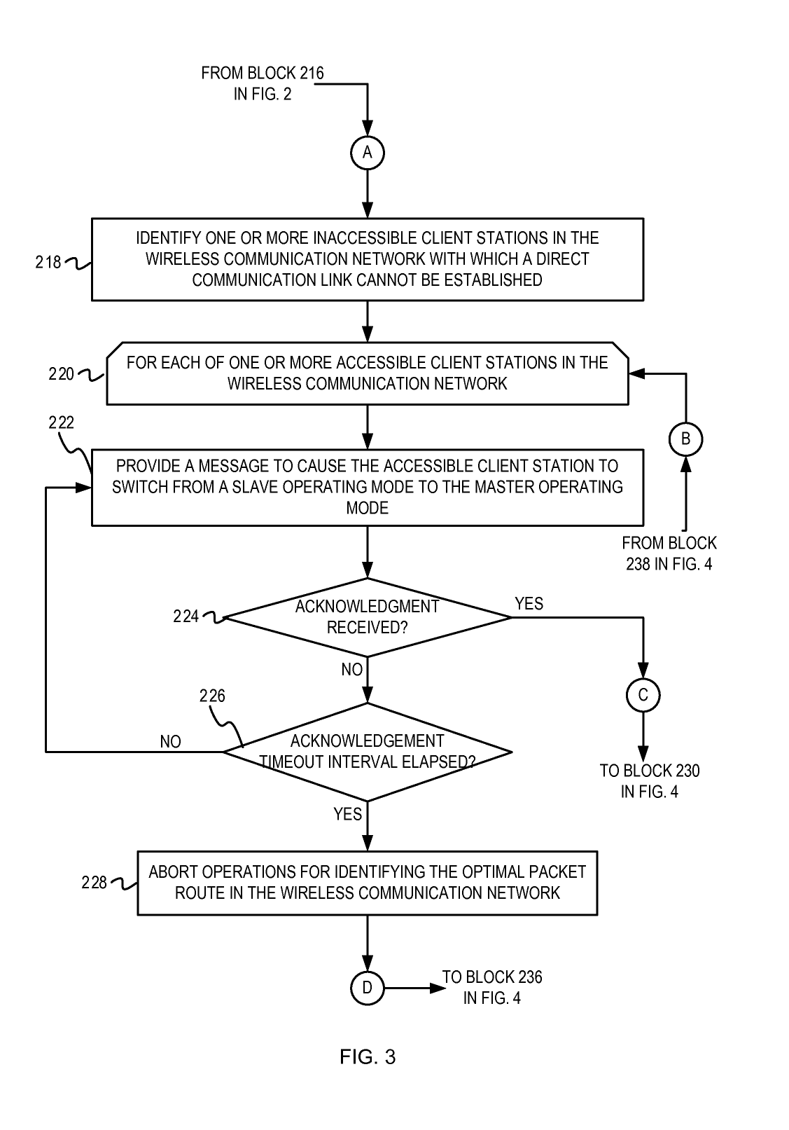

FIG. 2, FIG. 3, and FIG. 4 depict a flow diagram (“flow”) 200 illustrating example operations of a coordinating device configured to identify forwarding devices in a wireless communication network. The flow begins at block 202 in FIG. 2.

At block 202, a coordinating device configured in a master operating mode determines to identify an optimal packet route for client stations in a wireless communication network. For example, with reference to FIG. 1, the coordinating device 102 can determine to identify an optimal packet route for communicating with each client station 108, 110, and 114 in the wireless communication network 100. In some implementations, the performance analysis unit 104 can determine to identify the optimal packet route for each client station 108, 110, and 114 in response to a trigger from a network administrator. In another implementation, the performance analysis unit 104 can determine to identify the optimal packet route for one or more client stations with which the coordinating device 102 is programmed to communicate. In another implementation, the performance analysis unit 104 can determine to identify the optimal packet route for each client station at periodic intervals. In some implementations, the performance analysis unit 104 can determine to identify the optimal packet route after the coordinating device 102 establishes direct communication links (e.g., TDLS links) with one or more client stations. The flow continues at block 204.

At block 204, one or more client stations in the wireless communication network are identified. For example, the performance analysis unit 104 can identify the client stations 108, 110, and 114 in the wireless communication network 100. The performance analysis unit 104 can also identify an access point 130 associated with the wireless communication network 100. In one implementation, the performance analysis unit 104 can automatically identify the client stations 108, 110, and 114 in the wireless communication network 100. For example, as described above, the coordinating device 102 can identify and exchange handshake messages with client stations that support a direct communication protocol (e.g., the TDLS protocol) and can attempt to establish a direct communication link with each of the client stations. In another implementation, the network administrator may program information identifying the client stations 108, 110, and 114 into the performance analysis unit 104. However, it is noted that in other implementations, the one or more client stations are identified by other techniques; for example, the performance analysis unit 104 can identify the one or more client devices based on a message transmitted by the access point 130 identifying the client stations 108, 110, and 114 in the wireless communication network 100. The flow continues at block 206.

At block 206, a loop begins for each of the one or more client stations in the wireless communication network. For example, the performance analysis unit 104 can initiate a loop for executing the set of operations described with reference to blocks 208-214 to determine the throughput associated with a communication link between the coordinating device 102 and each of the one or more client stations. The flow continues at block 208.

At block 208, a training packet is transmitted to the client station. For example, the performance analysis unit 104 can transmit the training packet to the client station 114. In one implementation, the training packet can comprise predetermined data (e.g., a predetermined combination of zeros and ones). In another implementation, the performance analysis unit 104 can randomly generate (e.g., using a random number generator) the data to be transmitted within the training packet. The flow continues at block 210.

At block 210, an acknowledgment message is received from the client station in response to transmitting the training packet. For example, the performance analysis unit 104 can receive an acknowledgment message (e.g., an ACK packet, a block ACK packet, etc.) that indicates receipt of the training packet at the client station 114. The flow continues at block 212.

At block 212, one or more performance measurements are determined based on the received acknowledgement message. For example, the performance analysis unit 104 can determine one or more performance measurements in response to receiving the acknowledgement message from the client station 114 (at block 210). In one implementation, the performance analysis unit 104 can determine a data communication rate (e.g., a physical layer (PHY) rate), a packet error rate (PER), a packet success rate, a number of overhead bits exchanged via the communication link (i.e., a total number of overhead bits in the training packet and the acknowledgement message), and/or other performance measurements. The number of overhead bits can vary depending on the communication protocol implemented by the coordinating device 102 and the client station 114. In one implementation, the performance analysis unit 104 may not determine the exact number of overhead bits exchanged via the communication link between the coordinating device 102 and the client station 114. Instead, the performance analysis unit 104 may estimate (or heuristically determine) a factor (k) that is proportional to the number of overhead bits exchanged via the communication link between the coordinating device 102 and the client station 114. The flow continues at block 214.

At block 214, the coordinator-client throughput associated with the communication link between the coordinating device and the client station is calculated based on the one or more performance measurements. For example, when the coordinating device 102 is configured in the master operating mode, the performance analysis unit 104 can determine the coordinator-client throughput associated with communication link 118 between the coordinating device 102 and the client station 114 based on the one or more performance measurements determined at block 212. In one implementation, the coordinator-client throughput can be calculated as a product of the PHY rate, the packet success rate, and the number of overhead bits exchanged via the communication link 118, as depicted with reference to Eq. 1. With reference to Eq. 1, k represents a scale factor that is proportional to the overhead associated with the communication protocol implemented at the coordinating device 102 and at the client station 114. Also, the factor k*PHY rate represents the effective throughput achieved for a specified PHY rate.

Throughput=k*PHY rate*(1−PER) Eq. 1

It is noted that Eq. 1 is one example representation of the coordinator-client throughput. It is noted that the coordinator-client throughput calculated based on the product of the PHY rate, the packet success rate, and the number of overhead bits exchanged via the wireless communication link (as depicted with reference to Eq. 1) may also be referred to as the coordinator-client goodput. In one example, goodput can be defined as a measure of useful bits exchanged via the wireless communication links, and which excludes dropped packets, packet retransmissions, and protocol overhead. In other implementations, the coordinator-client throughput can be calculated using any suitable combination of performance measurements and/or any suitable throughput (or goodput) estimation techniques. For example, in addition to the PHY rate, the PER, and the number of overhead bits, other performance measurements such as RSSI, error vector magnitude (EVM), etc. can also be taken into consideration in calculating the coordinator-client throughput. In other embodiments, instead of calculating the coordinator-client throughput, individual performance measurements (e.g., the PER) can be analyzed to quantify the quality of the communication link 118 between the coordinating device 102 and the client station 114. In some implementations, the performance analysis unit 104 can also populate a coordinator throughput table. The coordinator throughput table can comprise identifying information (e.g., a network address and/or association ID) associated with the client station 114 and the corresponding coordinator-client throughput. The performance analysis unit 104 can maintain the coordinator throughput table in a file, a predetermined memory location, an external storage device, or other suitable storage locations. The flow continues at block 216.

At block 216, it is determined whether additional client stations in the wireless communication network are to be analyzed. For example, the performance analysis unit 104 can determine whether additional client stations are to be analyzed. If it is determined that there exist additional client stations in the wireless communication network 100 to be analyzed, the flow continues at block 206, where the next client station is identified and operations described above with reference to blocks 208-214 are executed for the next client station. Otherwise, the flow continues at block 218 in FIG. 3.

At block 218, one or more client stations with which a direct communication link cannot be established (“inaccessible client stations”) is identified. For example, the performance analysis unit 104 can identify the inaccessible client stations (from the client stations 108, 110, and 114) with which the coordinating device 102 cannot establish a direct communication link. In some implementations, the inaccessible client stations can be identified based on the coordinator-client throughput. For example, the performance analysis unit 104 can determine that a direct communication link between the coordinating device 102 and the client station 108 cannot be established, if the performance analysis unit 104 is unable to calculate the coordinator-client throughput associated with the client station 108. As another example, the performance analysis unit 104 can determine that a direct communication link between the coordinating device 102 and the client station 108 cannot be established, if the performance analysis unit 104 does not receive acknowledgement messages (or other response messages) in response to transmitted control/data/management packets. As another example, the performance analysis unit 104 can determine that the direct communication link between the coordinating device 102 and the client station 108 cannot be established, if the coordinator-client throughput associated with the client station 108 is less than a predetermined throughput threshold. In some implementations, the predetermined throughput threshold may be dependent, at least in part, on performance requirements associated with the coordinating device 102 and the client station 108. In other implementations, the predetermined throughput threshold is also configurable. On identifying the client station 108 with which the direct communication link cannot be established, the performance analysis unit 104 can populate an inaccessible client data structure and mark the client station 108 as an inaccessible client station. The flow continues at block 220.

At block 220, a loop begins for each of the one or more client stations in the wireless communication network with which a direct communication link can be established (“accessible client stations”). For example, the performance analysis unit 104 can initiate a loop for executing (in conjunction with each of the one or more accessible client stations) the set of operations described with reference to blocks 322-336 to receive client throughput tables from each of the one or more accessible client stations (e.g., client stations 110 and 114). In some implementations, the performance analysis unit 104 can determine to request the client throughput tables from a predetermined subset of the accessible client stations in the wireless communication network 100. The flow continues at block 222.

At block 222, a control message is provided to the accessible client station to cause the accessible client station to switch from a slave operating mode to the master operating mode. For example, the performance analysis unit 104 can provide the control message to cause the accessible client station (e.g., the client station 110) to switch from the slave operating mode to the master operating mode. In other words, after the coordinator throughput table is populated, the performance analysis unit 104 can provide the control message to the client station 110 to cause the client station 110 to assume the role of the coordinating device in the wireless communication network 100. After switching to the master operating mode, the client station 110 can establish communication links with the other client stations 108 and 114 in the wireless communication network 100, as will further be described with reference to FIG. 5. The client station 110 can determine the throughput associated with a communication link between the client station 110 and the other client stations 108 and 114 in the wireless communication network 100. The flow continues at block 224.

At block 224, it is determined whether an acknowledgement message was received from the accessible client station. For example, the performance analysis unit 104 can determine whether the acknowledgement message indicating receipt of the control message was received from the client station 110. If it is determined that the acknowledgement message was not received from the accessible client station, the flow continues at block 226. Otherwise, the flow continues at block 230 in FIG. 4.

At block 226, it is determined whether an acknowledgement timeout interval is elapsed for the accessible client station. For example, the performance analysis unit 104 can determine whether the acknowledgement timeout interval is elapsed, in response to determining that the acknowledgement message was not received from the client station 110 (after transmitting the control message to the client station). The acknowledgement timeout interval can indicate a maximum time duration for which the coordinating device 102 waits to receive the acknowledgement message from the client station 110. If it is determined that the acknowledgement timeout interval is elapsed for the accessible client station, the flow continues at block 228. Otherwise, the flow loops back to block 222, where the performance analysis unit 104 can retransmit the control message to the client station 110 to prompt the client station 110 to switch to the master operating mode and to determine the client throughput table.

At block 228, operations for identifying the optimal packet route in the wireless communication network are aborted for the client device. The flow 200 moves from block 226 to block 228 if the performance analysis unit 104 determines that the acknowledgement message was not received from the client station 110 and that the acknowledgement timeout interval has elapsed for the client station 110. The performance analysis unit 104 can cause the coordinating device 102 to remain in the master operating mode. The flow continues at block 236 in FIG. 4.

At block 230 in FIG. 4, the coordinating device 102 switches from the master operating mode to the slave operating mode. The flow 200 moves from block 224 in FIG. 3 to block 230 in FIG. 4 if the performance analysis unit 104 determines that the acknowledgement message was received from the client device 110 in response to the performance analysis unit 104 transmitting the control message at block 222. The flow continues at block 232.

At block 232, a client throughput table comprising throughputs associated with communication links between the client station currently configured in the master operating mode and one or more client stations configured in the slave operating mode is received. For example, when the client station 110 is configured in the master operating mode, the performance analysis unit 104 can receive the client throughput table from the client station 110. The client throughput table generated by the client station 110 can comprise throughputs associated with direct communication links between the client station 110 and the client station 108, and between the client station 110 and the client station 114. Operations describing the client station 110 generating the client throughput table will further be described with reference to FIG. 5. The flow continues at block 234.

At block 234, the coordinating device switches from the slave operating mode to the master operating mode. For example, in response to receiving the client throughput table, the performance analysis unit 104 can cause the coordinating device 102 to switch from the slave operating mode to the master operating mode. The performance analysis unit 104 can also transmit another control message to the client station 110 to cause the client station 110 to switch to the slave operating mode. The flow continues at block 236.

At block 236, it is determined whether additional accessible client stations in the wireless communication network are to be analyzed. For example, the performance analysis unit 104 can determine whether client throughput tables are to be received from additional accessible client stations in the wireless communication network 100. In some implementations, the performance analysis unit 104 can determine whether client throughput tables were received from all the accessible client stations 110 and 114 in the wireless communication network 100. In another implementation, the performance analysis unit 104 can determine whether client throughput tables were received from a predetermined subset of the accessible client stations in the wireless communication network 100. If it is determined that there exist additional accessible client stations in the wireless communication network 100 to be analyzed, the flow continues at block 220 in FIG. 3, where the next accessible client station is identified and operations described above with reference to blocks 222-236 are executed for the next accessible client station. Otherwise, the flow continues at block 238 in FIG. 4.

At block 238, throughputs associated with communication links between the coordinating device and each of the inaccessible client stations (“inaccessible destination client station”) via another client station (“potential forwarding client”) is calculated based on the coordinator throughput table and the client throughput tables. For example, the performance analysis unit 104 can determine cumulative throughputs that are representative of the throughput associated with the communication link between the coordinating device 102 and the inaccessible destination client station (e.g., the inaccessible client station 108) via the potential forwarding client (e.g., the client station 110). The performance analysis unit 104 can determine the cumulative throughputs based on the coordinator throughput table (determined at block 214) and the client throughput tables (determined at block 232). In some implementations, the performance analysis unit 104 can calculate the cumulative throughput associated with the communication link between the coordinating device 102 and the inaccessible destination client station 108 via the potential forwarding client 110 in accordance with Eq. 2. In other implementations, the performance analysis unit 104 can calculate the throughput associated with the communication link between the coordinating device 102 and the inaccessible destination client station 108 via the potential forwarding client 110 in accordance with Eq. 3, which is a simplified representation of Eq. 2. In Eq. 2 and Eq. 3, client1 represents the potential forwarding client and client2 represents the inaccessible destination client station.

$$\begin{matrix}Coordinator\_Client1 \_Client2 througput = \frac{\begin{matrix}( Coordinator\_Client1 throughput ) * \\ ( Coordinator\_Client2 throughput )\end{matrix}}{\begin{matrix}( Coordinator\_Client1 throughput ) + \\ ( Coordinator\_Client2 throughput )\end{matrix}} & Eq . 2 \\ Coordinator\_Client1 \_Client2 througput = \frac{1}{2} * min ( \begin{matrix}Coordinator\_Client throughput , \\ Client1\_Client2 throughput\end{matrix} ) & Eq . 3\end{matrix}$$

For the inaccessible destination client station 108, the performance analysis unit 104 of the coordinating device 102 may determine that both the accessible client stations 110 and 114 could establish a direct communication link with the coordinating device 102 and with the inaccessible destination client station 108. Therefore, the performance analysis unit 104 can designate the accessible client stations 110 and 114 as potential forwarding clients associated with the inaccessible destination client station 108. The performance analysis unit 104 can calculate the cumulative throughputs associated with a communication link with the inaccessible destination client station 108 via the potential forwarding client 110 and with a communication link with the inaccessible destination client station 108 via the potential forwarding client 114. The flow continues at block 240.

At block 240, for each of the inaccessible client stations, a forwarding client station through which to communicate with the inaccessible client station is determined. For example, the routing unit 106 can select the forwarding client station (from the potential forwarding clients) through which a packet from the coordinating device 102 can be routed to the inaccessible destination client station 108, based on the cumulative throughputs calculated at block 238. The routing unit 106 can determine the forwarding client station associated with those client stations in the wireless communication network 100 that were identified as inaccessible client stations. For example, the routing unit 106 may determine that the destination client station 108 is an inaccessible client station (i.e., that a direct communication link between the client station 108 and the coordinating device 102 cannot be established). Consequently, the routing unit 106 can analyze the cumulative throughputs associated with the communication links between the coordinating device 102 and the inaccessible destination client station 108 via the potential forwarding clients 110 and 114. The routing unit 106 can compare the throughput associated with the communication link between the coordinating device 102 and the inaccessible destination client station 108 via the potential forwarding client 110 against the throughput associated with the communication link between the coordinating device 102 and the inaccessible destination client station 108 via the potential forwarding client 114. The routing unit 106 can designate one of the potential forwarding clients 110 or 114 that yields the best cumulative throughput as the forwarding client station. In other words, the routing unit 106 can select the potential forwarding client 110 as the forwarding client associated with the inaccessible destination client station 108 if the cumulative throughput via the potential forwarding client 110 is greater than the cumulative throughput via the potential forwarding client 114. The flow continues at block 242.

At block 242, an indication of the forwarding client station associated with each of the inaccessible client stations is stored. In one implementation, the routing unit 106 can store the indication of the forwarding client stations associated with each of the inaccessible client stations in a routing data structure. For example, the routing unit 106 may indicate, in the routing data structure, that the inaccessible destination client station 108 is associated with the forwarding client station 110. In other words, on determining to transmit a packet from the coordinating device 102 to the inaccessible destination client station 108, the routing unit 106 can first transmit the packet to the forwarding client station 110 and cause the forwarding client station 110 to forward the packet to the inaccessible destination client station 108 The routing unit 108 may not store any information regarding the accessible client stations. Thus, on determining to transmit a packet to a destination client station, the routing unit 106 can access the routing data structure and determine whether an entry corresponding to the destination client station exists in the routing data structure. If an entry exists, the routing unit 106 can determine that the destination client station is an inaccessible client station and can route the packets to the destination client station via the corresponding forwarding client station. If an entry does not exist, the routing unit 106 can determine that the destination client station is an accessible client station and can route the packets to the destination client station via the direct communication link. From block 242, the flow ends.

It is noted that although FIG. 3 describes the performance analysis unit 104 successively transmitting the training packet to the client stations 108, 110, and 114, embodiments are not so limited. In other embodiments, the performance analysis unit 104 may broadcast the training packet to all the client stations 108, 110, and 114 in the wireless communication network 100. The performance analysis unit 104 can then wait to receive (from each of the client stations) acknowledgement messages that indicate receipt of the broadcast training packet.

Although flow 200 shown in FIG. 4 describes that the performance analysis unit 104 can calculate the cumulative throughput associated with a communication link between the coordinating device 102 and the destination client station 108 via the potential forwarding clients 110 and 114 when the destination client station 108 was deemed to be an inaccessible client station (see block 238), embodiments are not so limited. In another implementation, the performance analysis unit 104 may calculate the cumulative throughput associated with a communication link between the coordinating device 102 and the destination client station 108 via the potential forwarding clients 110 and 114 irrespective of whether a direct communication link between the coordinating device 102 and the destination client 108 can be established. The performance analysis unit 104 can then compare cumulative throughputs associated with communication links between the coordinating device 102 and the client station 108 via one or more potential forwarding clients against the throughput associated with the direct communication link between the coordinating device 102 and the client station 108. In one example, the coordinating device 102 can select the communication link that yields the best throughput for communicating with the client station 108. In another example, the coordinating device 102 can select the communication link that yields the best throughput by a predetermined margin. Furthermore, in some implementations, if the routing unit 106 determines that the coordinating device 102 should directly communicate with the client station 114, the routing unit 106 may indicate (e.g., in the routing data structure) that the destination client station 114 is not associated with any forwarding client stations. In other words, on determining to transmit a packet from the coordinating device 102 to the destination client station 114, the routing unit 106 can directly transmit the packet to the destination client station 114 via a direct communication link between the coordinating device 102 and the destination client station 114.

FIG. 5 is a flow diagram 500 illustrating example operations of a client station communicating with a coordinating device configured to select forwarding devices in a wireless communication network. The flow 500 begins at block 502.

At block 502, the client station is initialized in the slave operating mode. For example, with reference to FIG. 1, after the client station 110 is powered on, the client station 110 can initialize in the slave operating mode. The client station 110 can detect and associate with an access point 130 associated with the wireless communication network 100. The client station 110 may also attempt to establish a direct communication link (e.g., a TDLS link) with the coordinating device 102 of the wireless communication network 100. The client station 110 can then disassociate and disconnect from the access point 130, when the client station 110 establishes the direct communication link 116 with the coordinating device 102. The flow continues at block 504.

At block 504, a training packet is received from the coordinating device. For example, the performance analysis unit 112 of the client station 110 can receive the training packet from the coordinating device 102 via the direct communication link (e.g., the TDLS link 116) between the coordinating device 102 and the client station 110. It is noted that in some implementations, the performance analysis unit 112 can receive more than one training packet from the coordinating device 102 during different time intervals. The flow continues at block 506.

At block 506, an acknowledgement message is transmitted to the coordinating device in response to receiving the training packet. For example, the performance analysis unit 112 can transmit the acknowledgement message (e.g., an ACK packet) to the coordinating device 102 to indicate receipt of the training packet. In one implementation, if the performance analysis unit 112 receives more than one training packet from the coordinating device 102, the performance analysis unit 112 can transmit a separate acknowledgment message to indicate receipt of each training packet. In another implementation, if the performance analysis unit 112 receives more than one training packet from the coordinating device 102, the performance analysis unit 112 can transmit a block acknowledgment message (e.g., a block ACK packet) to indicate receipt of multiple training packets. The flow continues at block 508.

At block 508, an indication to switch from the slave operating mode to the master operating mode is received. For example, the performance analysis unit 112 can receive a control message from the corresponding performance analysis unit 104 of the coordinating device 102 that prompts the client station 110 to switch from the slave operating mode to the master operating mode. The coordinating device 102 can also prompt the client station 110 to calculate the throughputs associated with communication links between the client station 110 and the other client stations 108 and 114 configured in the slave operating mode. The flow continues at bock 510.

At block 510, the client station switches to the master operating mode and connects to one or more other client stations in the wireless communication network. For example, the performance analysis unit 112 can cause the client station 110 to switch to the master operating mode in response to receiving the control message from the coordinating device 102. Next, the client station 110 can attempt to establish a direct communication link with the other client stations 108 and 114 in the wireless communication network 100. The flow continues at block 512.

At block 512, the throughput associated with the communication link between the client station currently configured in the master operating mode and each of the other client stations is calculated. For example, the performance analysis unit 112 can calculate the throughput associated with the communication link between the client station 110 currently configured in the master operating mode and each of the other client stations 108 and 114 with which the client station 110 could establish a direct communication link. As described above with reference to blocks 208-214 of FIG. 2, the performance analysis unit 112 can transmit one or more training packets to the client stations 108 and 114 and can receive acknowledgement messages from the client stations 108 and 114. The performance analysis unit 112 can determine performance measurements associated with the received acknowledgement messages. Consequently, based on the determined performance measurements, the performance analysis unit 112 can calculate the throughputs associated with the communication link between the client station 110 and each of the other client stations 108 and 114 with which the client station 110 could establish a direct communication link, as described with reference to Eq. 1. The flow continues at block 514.

At block 514, a client throughput table is populated to comprise the throughput associated with the communication links between the client station currently configured in the master operating mode and each of the other client stations in the wireless communication network. For example, the performance analysis unit 112 can store the throughputs (calculated at block 512) in the client throughput table. The flow continues at block 516.

At block 516, the client throughput table is provided to the coordinating device. For example, the performance analysis unit 112 can provide the client throughput table to the coordinating device 102. As described above, with reference to block 238 of FIG. 4, the coordinating device 102 can use the client throughput table in conjunction with the coordinator throughput table (determined at block 214) to identify forwarding client stations through which to route packets to destination client stations. The flow continues at block 518.

At block 518, the client station switches from the master operating mode to the slave operating mode. In one implementation, the performance analysis unit 112 can cause the client station 110 to switch to the slave operating mode, in response to receiving a second control message from the coordinating device 102. In another implementation, the performance analysis unit 112 can cause the client station 110 to switch to the slave operating mode as soon as the client throughput table is provided to the coordinating device 102. In another implementation, the performance analysis unit 112 can wait to receive an acknowledgement message that indicates receipt of the client throughput table at the coordinating device 102. The performance analysis unit 112 can retransmit the client throughput table if the acknowledgment message is not received. The performance analysis unit 112 can abort operations for identifying an optimal packet transmission route if the acknowledgement message is not received within a predetermined timeout interval. Consequently, the performance analysis unit 112 can cause the client station 110 to switch to the slave operating mode. From block 518, the flow ends.

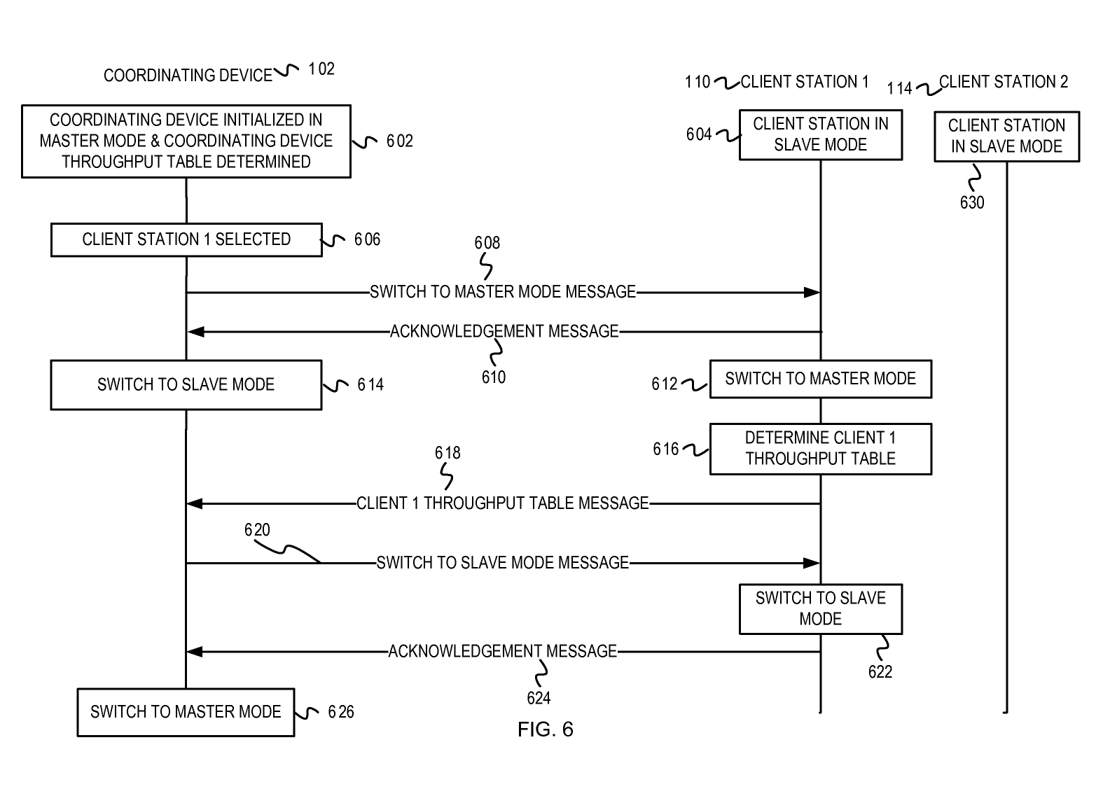

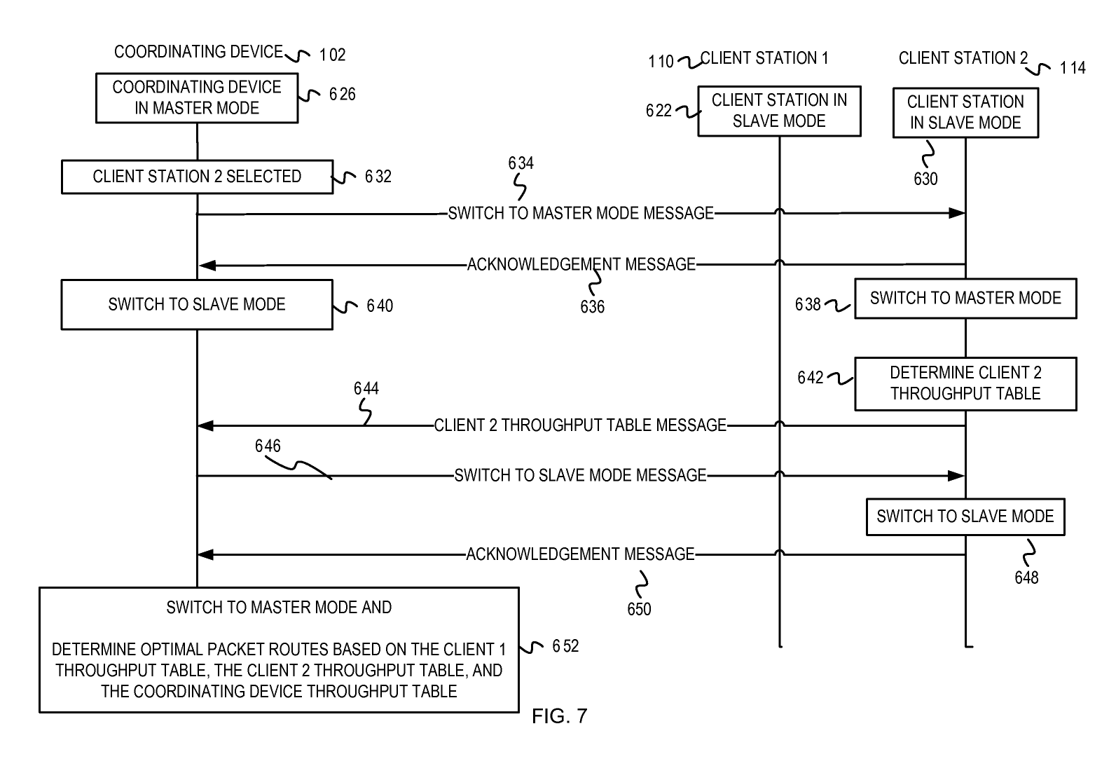

In some implementations, finite state machines can be implemented on the coordinating device 102 and on each of the client stations 108, 110, and 114 to facilitate the exchange of throughput tables and other control messages between the coordinating device 102 and the client stations 108, 110, and 114. The timing diagram 600 of FIGS. 6 and 7 illustrates example messages exchanged between the coordinating device 102 and the client stations 110 and 114 for identifying a forwarding client station associated with the inaccessible client station 108.

FIG. 6 and FIG. 7 illustrate an example timing diagram 600 illustrating example messages exchanged for selecting forwarding devices in a wireless communication network.

After the coordinating device 102, client station 1 (e.g., the client station 110), and client station 2 (i.e., the client station 114) are powered on, the coordinating device 102 initializes in the master operating mode (depicted in state 602), while the client stations 110 and 114 initialize in the slave operating mode (depicted in states 604 and 630 respectively). The client stations 110 and 114 connect with and establish a direct communication link with the coordinating device 102. As depicted by the state 602, the coordinating device 102 calculates the coordinator throughput table (described above with reference to blocks 208-214 of FIG. 2). At state 606, the coordinating device 102 identifies and selects the client station 110. The coordinating device 102 transmits a control message 608 directing the client station 110 to switch from the slave operating mode to the master operating mode. The client station 110 transmits an acknowledgment message 610 in response to receiving the control message 608.

After the coordinating device 102 receives the acknowledgment message 610, the coordinating device 102 switches to the slave operating mode as depicted in state 614. As depicted by state 612, the client station 110 switches to the master operating mode. The client station 110 configured in the master operating mode connects to the coordinating device 102 (and the other client station 114) in the slave operating mode. At state 616, the client station 110 determines the client throughput table as described above with reference to blocks 510-514 of FIG. 5. The client station 110 transmits (to the coordinating device 102) a message 618 comprising the client throughput table. The coordinating device 102 transmits another control message 620 directing the client station 110 to switch from the master operating mode to the slave operating mode. The client station 110 transmits the acknowledgment message 624 in response to receiving the control message 620. As depicted in state 626, the coordinating device 102 switches to the master operating mode in response to receiving the acknowledgment message 624. The client station 110 also switches to the slave operating mode as depicted by state 622. Referring now to FIG. 7, the coordinating device 102 is configured in the master operating mode (see state 626) and the client devices 110 and 114 are configured in the slave operating mode (see states 622 and 630 respectively).

At state 632, the coordinating device 102 identifies and selects the client station 114. The coordinating device 102 transmits a control message 634 directing the client station 114 to switch from the slave operating mode to the master operating mode. The client station 114 transmits acknowledgment message 636 in response to receiving the control message 634. After the coordinating device 102 receives the acknowledgment message 634, the coordinating device 102 switches to the slave operating mode as depicted in state 640 and the client station 114 switches to the master operating mode as depicted by state 638. The client station 114 configured in the master operating mode connects to the coordinating device 102 (and the other client station 110) in the slave operating mode. At state 642, the client station 114 determines the client throughput table as described above with reference to blocks 510-514 of FIG. 5. The client station 114 transmits (to the coordinating device 102) a message 644 comprising the client throughput table. The coordinating device 102 transmits another control message 646 directing the client station 114 to switch from the master operating mode to the slave operating mode. The client station 114 switches to the slave operating mode at state 648 and transmits the acknowledgment message 650 to indicate receipt of the control message 646.

At state 652, the coordinating device 102 switches back to the master operating mode. At state 652, the coordinating device 102 also analyses the coordinator throughput table and the client throughput tables received from the client stations 110 and 114. Based on knowledge of inaccessible client stations (e.g., the client station 108) in the wireless communication network and based on the throughputs in the aforementioned throughput tables, the coordinating device 102 can select either the client station 110 or the client station 114 as the forwarding client station associated with the inaccessible client station 108. The coordinating device 102 can store an indication of the forwarding client station associated with each of the inaccessible client stations. Although not depicted in FIG. 7, the coordinating device 102 can transmit an “analysis complete” message to the client stations 110 and 114 to indicate that the requisite analysis for identifying the optimal packet communication routes is completed.

It should be understood that FIGS. 1-7 are examples meant to aid in understanding embodiments and should not be used to limit embodiments or limit scope of the claims. Embodiments may perform additional operations, fewer operations, operations in a different order, operations in parallel, and some operations differently. For example, although FIGS. 1-7 describe the performance analysis unit 104 of the coordinating device 102 identifying forwarding client stations, embodiments are not so limited. In other embodiments, any one of the client stations 108, 110, and 114 can implement functionality for identifying the forwarding client stations and determining the optimal packet communication routes. In some implementations, the performance analysis unit 104 can determine whether the direct communication link with the client station (if one can be established) yields a better performance as compared to a communication link with the destination client station (referred to below as client2) via a forwarding client station (referred to below as client 1). In some implementations, the performance analysis unit 104 may determine whether the coordinator-client1-client2 throughput is greater than the coordinator-client2 throughput to determine whether the coordinating device 102 should communicate with client2 via a direct connection or via client1. In another implementation, the performance analysis unit 104 may determine whether the coordinator-client1-client2 throughput exceeds the coordinator-client2 throughput by a predetermined margin (e.g., by 25%) to determine whether the coordinating device 102 should communicate with client2 via a direct connection or via client1. The performance analysis unit 104 may select client1 as the forwarding client station even if a direct communication link between the coordinating device 102 and client2 can be established, if the coordinating device 102 determines that coordinator-client2 throughput exceeds the coordinator-client1-client2 throughput by the predetermined margin. The predetermined margin can be selected to maintain a balance between decrease in communication bandwidth if the coordinating device 102 communicates with client2 via client 1 and a corresponding increase in throughput. In determining whether the coordinating device 102 should communicate with client2 via a direct connection or via client1, the performance analysis unit 104 may also take available communication bandwidth and the performance requirements associated with the coordinating device 102, client1, and client 2 into consideration. It is noted, however, if the coordinator-client2 throughput does not exceed the coordinator-client1-client2 by the predetermined margin, the performance analysis unit 104 may choose to communicate with client2 via the direct communication link.

In some implementations, the coordinating device 102 can determine whether the direct communication link with the client station (if one can be established) yields better performance as compared to a communication link with the client station via an access point 130 associated with the wireless communication network 100. In some implementations, if the coordinating device 102 determines that the client station is an inaccessible client station, the coordinating device 102 can determine whether a communication link with the inaccessible client station via an identified forwarding client station yields better performance as compared to a communication link with the inaccessible client station via the access point 130. In another implementation, the coordinating device 102 may attempt to route packets to the inaccessible client station via the access point 130 if another forwarding client station associated with the inaccessible client station cannot be identified.

Furthermore, although FIG. 2 describes the client stations (e.g., the client station 110) calculating client throughput tables that comprise throughputs associated with communication links between the client station 110 and all other client stations 108 and 114 in the wireless communication network 100, embodiments are not so limited. In other embodiments, as part of the indication to switch from the master operating mode to the slave operating mode (i.e., the control message), the coordinating device 102 can indicate the inaccessible client stations. The client station 110 that receives the control message can switch to the master operating mode and can attempt to connect with the inaccessible client station 108. If the client station 110 can connect to the inaccessible client station 108, the client station 110 can determine and store (in the client throughput table) the throughput associated with the communication link between the client station 110 and the client station 108. The client station 110 can then transmit the client throughput table to the coordinating device 102. If the client station 110 is unable to connect to the inaccessible client station 108, the client station 110 can accordingly notify the coordinating device 102 that a communication link with the inaccessible client station 108 cannot be established.

Although FIGS. 1-5 depict the coordinating device 102 transmitting one training packet to the client stations 108, 110, and 114 to determine the coordinator-client throughput, embodiments are not so limited. In other embodiments, the coordinating device 102 can transmit any suitable number of training packets to determine the coordinator-client throughput. The coordinating device 102 can transmit multiple training packets over a programmable number of time intervals to guard against variations in PHY rate, PER, and other performance measurements due to attenuation, distortion and other interference effects. The number of time intervals can be selected to maintain an optimal balance between the total time required for executing the operations described herein and the accuracy of the calculations. In one implementation, the coordinating device 102 can receive an acknowledgement message for each of the transmitted training packets. The performance analysis unit 104 can determine the PHY rate and the PER associated with each of the received acknowledgement messages and can calculate the corresponding coordinator-client throughput. The performance analysis unit 104 can calculate an average coordinator-client throughput over the programmable number of time intervals. In another implementation, the coordinating device 102 can receive one acknowledgement message for multiple transmitted training packets (e.g., 1 block acknowledgement message per 10 transmitted training packets). Based on the number of block acknowledgement messages received, the performance analysis unit 104 can calculate the coordinator-client throughput or the average coordinator-client throughput. The performance analysis unit 104 can then use the calculated throughput values to determine the forwarding client stations, as described with reference to FIGS. 3-5.

Furthermore, although FIGS. 1-7 describe one of the wireless devices 102 in the wireless communication network 100 assuming the role of the coordinating device to identify the optimal packet communication routes, embodiments are not so limited. In other embodiments, the access point 130 associated with the wireless communication network 100 can itself execute the operations described herein for identifying the optimal packet communication routes. In other words, the access point 130 can assume the role of the coordinating device in the wireless communication network 100. The access point 130 can then initiate the operations described herein for analyzing throughputs associated with the communication links between the access point 130 and the other wireless devices 102, 108, 110, and 114 and between each of the wireless devices and for identifying the optimal packet communication routes. It is also noted that although examples refer to one of the client stations 110 and 114 being selected as the forwarding client station, embodiments are not so limited. Forwarding devices can comprise client stations, the access point 130, and any other suitable device that can establish a direct communication link with both the source wireless device (e.g., the coordinating device 102) and the destination wireless device (e.g., the client station 108).

In some implementations, the wireless communication network 100 can be a home network, the coordinating device 102 can be a set top box (STB) with digital video recording (DVR) functionality, and the client stations 108, 110, and 114 can be thin clients without storage/DVR functionality. As depicted with reference to FIG. 1, the thin client stations 108, 110, and 112 can attempt to connect to the coordinating STB device 102 using TDLS links. If the client station 110 is programmed to record content (e.g., a movie, a television show, etc.), the client station 110 can transmit a message to the coordinating STB device 102 to cause the coordinating STB device 102 to record and store the content. For example, the coordinating STB device 102 can connect to the Internet (e.g., via the access point 130), download Internet-based content (e.g., as requested by the client station 110) and store the downloaded Internet-based content. As another example, to access satellite-based content, only the coordinating STB device 102 may comprise a tuner (e.g., a satellite television tuner) to access, download, and store the satellite-based content. To display the content on the client station 110 (e.g., in response to a user request to play the video), the client station 110 can transmit a request for the requisite content to the coordinating STB device 102. The coordinating STB device 102, in turn, can stream the downloaded/stored content to the client station 110. As described above with reference to FIGS. 1-7, if the client station (e.g., the client station 108) is not accessible from the coordinating device 102 (e.g., the throughput is less than a predetermined threshold), the coordinating device 102 can identify a forwarding client station (e.g., client station 110) associated with the inaccessible client station 108. The coordinating STB device 102 can stream the requisite content to the inaccessible client station 108 via the forwarding client station 110. In some implementations, the inaccessible client station 108 may be notified of the forwarding client station 110 with which it is associated. Thus, if the inaccessible client station 108 is programmed to record content, the inaccessible client station 108 can transmit a request to the coordinating STB device 102 via the forwarding client station 110 to cause the coordinating STB device 102 to record the content.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). A machine-readable medium may be a machine-readable storage medium, or a machine-readable signal medium. A machine-readable storage medium may include, for example, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of tangible medium suitable for storing electronic instructions. A machine-readable signal medium may include a propagated data signal with computer readable program code embodied therein, for example, an electrical, optical, acoustical, or other form of propagated signal (e.g., carrier waves, infrared signals, digital signals, etc.). Program code embodied on a machine-readable signal medium may be transmitted using any suitable medium, including, but not limited to, wireline, wireless, optical fiber cable, RF, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider)

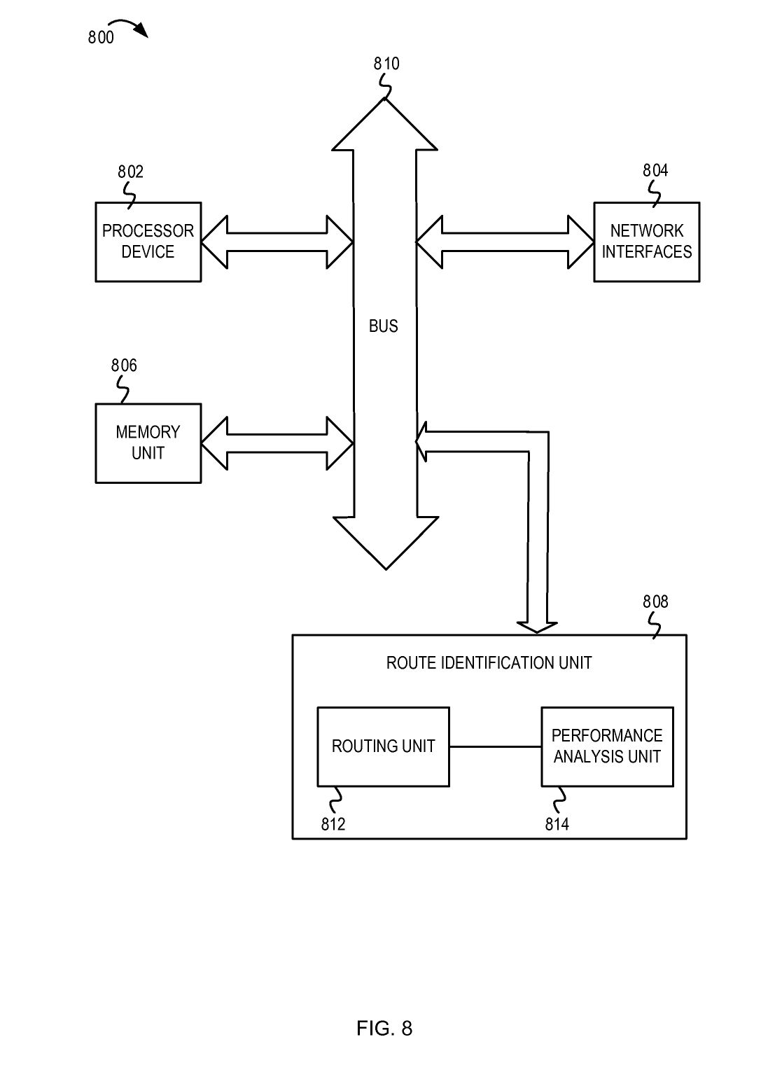

FIG. 8 is a block diagram of one embodiment of an electronic device 800 including a mechanism for identifying forwarding devices in a wireless communication network. In some implementations, the electronic device 800 may be one of a personal computer (PC), a laptop, a netbook, a television set top box (STB), a mobile phone, a personal digital assistant (PDA), or other electronic systems comprising a WLAN device with direct communication capabilities. In another implementation, the electronic device 800 can be a standalone WLAN device configured to establish a WLAN communication link with one or more other WLAN devices. The electronic device 800 includes a processor unit 802 (possibly including multiple processors, multiple cores, multiple nodes, and/or implementing multi-threading, etc.). The electronic device 800 includes a memory unit 806. The memory unit 806 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The electronic device 800 also includes a bus 810 (e.g., PCI, ISA, PCI-Express, HyperTransport®, InfiniBand®, NuBus, AHB, AXI, etc.). The electronic device 800 also includes network interfaces 804 that include at least one of a wireless network interface (e.g., a WLAN interface, a Bluetooth® interface, a WiMAX interface, a ZigBee® interface, a Wireless USB interface, etc.) and a wired network interface (e.g., an Ethernet interface, etc.).

The electronic device 800 also includes a route identification unit 808. The route identification unit 808 comprises a routing unit 812 and a performance analysis unit 814. The route identification unit 808 can implement operations described above with reference to FIGS. 1-4 and FIGS. 6-7, when the electronic device 800 is configured as a master coordinating device to identify forwarding devices associated with one or more WLAN client stations in the wireless communication network. In such a mechanism for identifying the forwarding devices, the other client stations of the wireless communication network (which may also be implemented as the electronic device 800 of FIG. 8) can implement operations described above with reference to FIGS. 5 and 6-7 to assist the master coordinating device in identifying the forwarding devices. Any one of these functionalities may be partially (or entirely) implemented in hardware and/or on the processor unit 802. For example, the functionality may be implemented with an application specific integrated circuit, in logic implemented in the processor unit 802, in a co-processor on a peripheral device or card, etc. Further, realizations may include fewer or additional components not illustrated in FIG. 8 (e.g., video cards, audio cards, additional network interfaces, peripheral devices, etc.). The processor unit 802, the memory unit 806, and the network interfaces 806 are coupled to the bus 810. Although illustrated as being coupled to the bus 810, the memory unit 806 may be coupled to the processor unit 802.

While the embodiments are described with reference to various implementations and exploitations, it will be understood that these embodiments are illustrative and that the scope of the inventive subject matter is not limited to them. In general, techniques for selecting forwarding devices in a wireless communication network as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising
determining a throughput associated with a direct communication link between a coordinating network device and each of a plurality of client stations associated with a wireless communication network;
identifying an inaccessible client station from the plurality of client stations that is inaccessible to the coordinating network device via the direct communication link, and one or more accessible client stations from the plurality of client stations that are accessible to the coordinating network device via the direct communication link, based, at least in part, on the throughput associated with the direct communication link between the coordinating network device and each of the plurality of client stations;
identifying an accessible client station from the one or more accessible client stations to designate as a forwarding client station with respect to the coordinating network device and the inaccessible client station based, at least in part, on a cumulative throughput associated with a communication link between the coordinating network device and the inaccessible client station via the accessible client station; and
transmitting data from the coordinating network device to the inaccessible client station via the forwarding client station.

2. The method of claim 1, wherein said determining the throughput associated with the direct communication link between the coordinating network device and each of the plurality of client stations associated with the wireless communication network further comprises:
for each of the plurality of client stations within the wireless communication network,
transmitting a training packet from the coordinating network device to the client station;
receiving an acknowledgement message from the client station in response to said transmitting the training packet from the coordinating network device to the client station;
analyzing the acknowledgement message to determine one or more performance measurements associated with the direct communication link between the coordinating network device and the client station; and
calculating the throughput associated with the direct communication link between the coordinating network device and the client station based, at least in part, on the one or more performance measurements associated with the direct communication link between the coordinating network device and the client station.

3. The method of claim 2, wherein the one or more performance measurements comprise a data rate associated with the acknowledgement message received at the coordinating network device, a packet error rate associated with the acknowledgement message, and a packet overhead associated with the training packet and the acknowledgement message.

4. The method of claim 3, wherein said calculating the throughput associated with the direct communication link between the coordinating network device and each of the plurality of client stations comprises calculating, for each of the plurality of client stations, a goodput associated with the communication link between the coordinating network device and the client station based, at least in part, on a data rate associated with the acknowledgement message received from the client station, a packet error rate associated with the acknowledgement message, and a packet overhead associated with the training packet and the acknowledgement message.

5. The method of claim 2, further comprising:
for each of the plurality of client stations within the wireless communication network,
determining whether the acknowledgement message was received from the client station, in response to said transmitting the training packet from the coordinating network device to the client station;
designating the client station as one of the one or more accessible client stations in response to determining that the acknowledgement message was received from the client station; and
designating the client station as the inaccessible client station in response to determining that the acknowledgement message was not received from the client station.

6. The method of claim 1, said determining the throughput associated with the direct communication link between the coordinating network device and each of the plurality of client stations further comprises:
for each of the plurality of client stations associated with the wireless communication network,
transmitting a plurality of training packets from the coordinating network device to the client station within a predetermined number of time intervals;
receiving a plurality of acknowledgement messages from the client station in response to said transmitting the plurality of training packets from the coordinating network device to the client station within the predetermined number of time intervals;
for each of the plurality of acknowledgement messages,
analyzing the acknowledgement message to determine one or more performance measurements associated with the direct communication link between the coordinating network device and the client station;
calculating an intermediate throughput associated with the direct communication link between the coordinating network device and the client station based, at least in part, on the or more performance measurements associated with the direct communication link between the coordinating network device and the client station; and
determining an average of the intermediate throughputs determined for each of the one or more acknowledgement messages to yield the throughput associated with the direct communication link between the coordinating network device and the client station.

7. The method of claim 1, wherein said identifying the accessible client station from the one or more accessible client stations to designate as the forwarding client station with respect to the coordinating network device and the inaccessible client station further comprises:
for each of the one or more accessible client stations associated with the wireless communication network,
calculating a cumulative throughput associated with a communication link between the coordinating network device and the inaccessible client station via the accessible client station, based on the throughput associated with the communication link between the coordinating network device and the accessible client station, and based on a throughput associated with a communication link between the accessible client station and the inaccessible client station;
identifying one of the one or more accessible client stations to designate as the forwarding client station with respect to the coordinating network device and the inaccessible client station based, at least in part, on said calculating the cumulative throughput of the communication link between the coordinating network device and the inaccessible client station via each of the one or more accessible client stations.

8. The method of claim 7, wherein said identifying one of the one or more accessible client stations to designate as the forwarding client station with respect to the coordinating network device and the inaccessible client station further comprises: comparing the cumulative throughputs of the communication link between the coordinating network device and the inaccessible client station via each of the one or more accessible client stations; and
designating the one of the one or more accessible client stations associated with the highest cumulative throughput as the forwarding client station.

9. The method of claim 7, wherein said calculating, for each of the one or more accessible client stations, the cumulative throughput associated with the communication link between the coordinating network device and the inaccessible client station via the accessible client station further comprises:
for each of the one or more accessible client stations associated with the wireless communication network,
calculating a product of the throughput associated with the direct communication link between the coordinating network device and the accessible client station and the throughput associated with the direct communication link between the accessible client station and the inaccessible client station;
calculating a sum of the throughput associated with the direct communication link between the coordinating network device and the accessible client station and the throughput associated with the direct communication link between the accessible client station and the inaccessible client station; and
dividing the calculated product by the calculated sum to yield the cumulative throughput associated with the communication link between the coordinating network device and the inaccessible client station via the accessible client station.

10. The method of claim 7, wherein said calculating, for each of the one or more accessible client stations, the cumulative throughput associated with the communication link between the coordinating network device and the inaccessible client station via the accessible client station further comprises:
for each of the one or more accessible client stations associated with the wireless communication network,
determining a minimum throughput value between the throughput associated with the direct communication link between the coordinating network device and the accessible client station and the throughput associated with the direct communication link between the accessible client station and the inaccessible client station;
multiplying the determined minimum throughput value by a predetermined scale factor to yield cumulative throughput associated with the communication link between the coordinating network device and the inaccessible client station via the accessible client station.

11. The method of claim 1, further comprising:
for each of the one or more accessible client stations associated with the wireless communication network,
determining whether a throughput associated with a direct communication link between the coordinating network device and the accessible client station exceeds a cumulative throughput associated with a communication link between the coordinating network device and the accessible client station via each of the one or more accessible client stations;
determining to communicate with the accessible client station via the direct communication link between the coordinating network device and the accessible client station, in response to determining that the throughput associated with the direct communication link exceeds the cumulative throughput associated with the communication link between the coordinating network device and the accessible client station via each of the one or more accessible client stations; and
identifying a second accessible client station from the one or more accessible client stations to designate as a forwarding client station with respect to the coordinating network device and the accessible client station, in response to determining that the throughput associated with the direct communication link does not exceed the cumulative throughput associated with the communication link between the coordinating network device and the accessible client station via the second accessible client station.

12. The method of claim 11, wherein, said determining whether the throughput associated with the direct communication link between the coordinating network device and each of the one or more accessible client stations exceeds the cumulative throughput associated with the communication link between the coordinating network device and the accessible client station via of the one or more accessible client stations comprises:
for each of the one or more accessible client stations associated with the wireless communication network,
determining whether the throughput associated with the direct communication link between the coordinating network device and the accessible client station exceeds the cumulative throughput associated with the communication link between the coordinating network device and the accessible client station via each of the one or more accessible client stations by a predefined margin.

13. The method of claim 1, further comprising:
receiving, from each of the one or more accessible client stations, an indication of a throughput associated with a direct communication link between the accessible client station and a remainder of the plurality of client stations.

14. The method of claim 13, wherein said receiving, from each of the one or more accessible client stations the indication of the throughput associated with the direct communication link between the accessible client station and the remainder of the plurality of client stations further comprises:
for each of the one or more accessible client stations,
providing, to the accessible client station, a control message to cause the accessible client station to switch from a slave operating mode to a master operating mode;
determining whether an acknowledgement message was received at the coordinating network device from the accessible client station, in response to said providing the control message to the accessible client station;
in response to determining that the acknowledgement message was received from the accessible client station,
causing the coordinating network device to switch from the master operating mode to the slave operating mode; and
causing the coordinating network device configured in the slave operating mode to associate with the accessible client station configured in the master operating mode;
receiving, from the accessible client station, the indication of the throughput associated with the direct communication link between the accessible client station and the remainder of the plurality of client stations; and
in response to determining that the acknowledgement message was not received from the accessible client station,
determining whether a timeout interval associated with the acknowledgement message is elapsed, wherein the timeout interval indicates a maximum time duration for which the coordinating network device waits to receive the acknowledgement message from the accessible client station;
retransmitting the control message to the accessible client station, in response to determining that the timeout interval associated with the acknowledgement message is not elapsed; and
aborting operations for identifying optimal packet communication routes, in response to determining that the timeout interval associated with the acknowledgement message is elapsed.

15. A communication network device comprising:
a processor;
a network interface coupled with the processor; and
a route identification unit coupled with the processor and the network interface, the route identification unit operable to:
determine a throughput associated with a direct communication link between the communication network device and each of a plurality of client stations associated with a wireless communication network;
identify an inaccessible client station from the plurality of client stations that is inaccessible to the communication network device via the direct communication link, and one or more accessible client stations from the plurality of client stations that are accessible to the communication network device via the direct communication link, based, at least in part, on the throughput associated with the direct communication link between the communication network device and each of the plurality of client stations;
identify an accessible client station from the one or more accessible client stations to designate as a forwarding client station with respect to the communication network device and the inaccessible client station based, at least in part, on a cumulative throughput associated with a communication link between the communication network device and the inaccessible client station via the accessible client station; and
transmit data from the communication network device to the inaccessible client station via the forwarding client station.

16. The communication network device of claim 15, wherein the route identification unit operable to determine the throughput associated with the direct communication link between the communication network device and each of the plurality of client stations associated with the wireless communication network further comprises the route identification unit operable to:
for each of the plurality of client stations within the wireless communication network,
transmit a training packet from the communication network device to the client station;
receive an acknowledgement message from the client station in response to the route identification unit transmitting the training packet from the communication network device to the client station;
analyze the acknowledgement message to determine one or more performance measurements associated with the direct communication link between the communication network device and the client station; and
calculate the throughput associated with the direct communication link between the communication network device and the client station based, at least in part, on the one or more performance measurements associated with the direct communication link between the communication network device and the client station.

17. The communication network device of claim 16, wherein the route identification unit is further operable to:
for each of the plurality of client stations within the wireless communication network,
determine whether the acknowledgement message was received from the client station, in response to the route identification unit transmitting the training packet from the communication network device to the client station;
designate the client station as one of the one or more accessible client stations in response to the route identification unit determining that the acknowledgement message was received from the client station; and
designate the client station as the inaccessible client station in response to the route identification unit determining that the acknowledgement message was not received from the client station.

18. The communication network device of claim 15, wherein the route identification unit operable to identify the accessible client station from the one or more accessible client stations to designate as the forwarding client station with respect to the communication network device and the inaccessible client station further comprises the route identification unit operable to:
for each of the one or more accessible client stations associated with the wireless communication network,
calculate a cumulative throughput associated with a communication link between the communication network device and the inaccessible client station via the accessible client station, based on the throughput associated with the communication link between the communication network device and the accessible client station, and based on a throughput associated with a communication link between the accessible client station and the inaccessible client station;
compare the cumulative throughputs of the communication link between the communication network device and the inaccessible client station via each of the one or more accessible client stations; and
designate the one of the one or more accessible client stations associated with the highest cumulative throughput as the forwarding client station.

19. The communication network device of claim 15, wherein the route identification unit is further operable to:
for each of the one or more accessible client stations associated with the wireless communication network,
determine whether a throughput associated with a direct communication link between the communication network device and the accessible client station exceeds a cumulative throughput associated with a communication link between the communication network device and the accessible client station via each of the one or more accessible client stations;
determine to communicate with the accessible client station via the direct communication link between the communication network device and the accessible client station, in response to the route identification unit determining that the throughput associated with the direct communication link exceeds the cumulative throughput associated with the communication link between the communication network device and the accessible client station via each of the one or more accessible client stations; and
identify a second accessible client station from the one or more accessible client stations to designate as a forwarding client station with respect to the communication network device and the accessible client station, in response to the route identification unit determining that the throughput associated with the direct communication link does not exceed the cumulative throughput associated with the communication link between the communication network device and the accessible client station via the second accessible client station.

20. One or more machine-readable storage media, having instructions stored therein, which, when executed by one or more processors causes the one or more processors to perform operations that comprise:
determining a throughput associated with a direct communication link between a coordinating network device and each of a plurality of client stations associated with a wireless communication network;
identifying an inaccessible client station from the plurality of client stations that is inaccessible to the coordinating network device via the direct communication link, and one or more accessible client stations from the plurality of client stations that are accessible to the coordinating network device via the direct communication link, based, at least in part, on the throughput associated with the direct communication link between the coordinating network device and each of the plurality of client stations;
for each of the one or more accessible client stations associated with the wireless communication network,
calculating a cumulative throughput associated with a communication link between the coordinating network device and the inaccessible client station via the accessible client station, based on the throughput associated with the communication link between the coordinating network device and the accessible client station, and based on a throughput associated with a communication link between the accessible client station and the inaccessible client station;
identifying one of the one or more accessible client stations to designate as a forwarding client station with respect to the coordinating network device and the inaccessible client station based, at least in part, on said calculating the cumulative throughput of the communication link between the coordinating network device and the inaccessible client station via each of the one or more accessible client stations; and
transmitting data from the coordinating network device to the inaccessible client station via the forwarding client station.

21. The machine-readable storage media of claim 20, wherein said operation of determining the throughput associated with the direct communication link between the coordinating network device and each of the plurality of client stations associated with the wireless communication network further comprises:
for each of the plurality of client stations within the wireless communication network,
transmitting a training packet from the coordinating network device to the client station;
receiving an acknowledgement message from the client station in response to said transmitting the training packet from the coordinating network device to the client station;
analyzing the acknowledgement message to determine one or more performance measurements associated with the direct communication link between the coordinating network device and the client station; and
calculating the throughput associated with the direct communication link between the coordinating network device and the client station based, at least in part, on the one or more performance measurements associated with the direct communication link between the coordinating network device and the client station.

22. The machine-readable storage media of claim 20, wherein said operation of identifying one of the one or more accessible client stations to designate as the forwarding client station with respect to the coordinating network device and the inaccessible client station further comprises:
comparing the cumulative throughputs of the communication link between the coordinating network device and the inaccessible client station via each of the one or more accessible client stations; and
designating the one of the one or more accessible client stations associated with the highest cumulative throughput as the forwarding client station.

23. The machine-readable storage media of claim 20, wherein the operations further comprise:
for each of the one or more accessible client stations associated with the wireless communication network,
determining whether a throughput associated with a direct communication link between the coordinating network device and the accessible client station exceeds a cumulative throughput associated with a communication link between the coordinating network device and the accessible client station via each of the one or more accessible client stations;
determining to communicate with the accessible client station via the direct communication link between the coordinating network device and the accessible client station, in response to determining that the throughput associated with the direct communication link exceeds the cumulative throughput associated with the communication link between the coordinating network device and the accessible client station via each of the one or more accessible client stations; and
identifying a second accessible client station from the one or more accessible client stations to designate as a forwarding client station with respect to the coordinating network device and the accessible client station, in response to determining that the throughput associated with the direct communication link does not exceed the cumulative throughput associated with the communication link between the coordinating network device and the accessible client station via the second accessible client station.
